(19) United States
(12) Patent Application Publication
(10) Pub. No.: US 2024/0324031 A1
(43) Pub. Date: Sep. 26, 2024

(54) TIMING FOR APERIODIC SOUNDING REFERENCE SIGNAL (SRS) TRANSMISSIONS

(71) Applicant: QUALCOMM INCORPORATED, San Diego, CA (US)

(72) Inventors: Fang Yuan, Beijing (CN); Luanxia Yang, Beijing (CN); Aleksandar Damnjanovic, Del Mar, CA (US); Mostafa Khoshnevisan, San Diego, CA (US); Jing Sun, San Diego, CA (US); Wooseok Nam, San Diego, CA (US); Tao Luo, San Diego, CA (US); Rajat Prakash, San Diego, CA (US); Xiaoxia Zhang, San Diego, CA (US)

(21) Appl. No.: 18/574,991

(22) PCT Filed: Sep. 1, 2021
(86) PCT No.: PCT/CN2021/115908

§ 371 Date: Dec. 28, 2023

(51) Int. Cl. H04W 76/10; H04B 7/06; H04L 5/00

(52) U.S. Cl. CPC H04W 76/10; H04B 7/0626; H04L 5/0051

(57) ABSTRACT

This disclosure provides systems, methods and apparatus for aperiodic sounding reference signal (SRS) transmissions. In some aspects, a user equipment (UE) or a network entity may determine one or more time intervals for sounding reference signal (SRS) transmissions from a type of link, such as a link with another UE or a link with the network entity, used to communicate control signaling that triggers the SRS transmissions for the UE. A time interval in which the UE may not expect to transmit SRSs after receiving the control signaling, a time interval between the control signaling and the associated SRSs, a time interval between the control signaling and reception of one or more channel state information reference signals (CSI-RSs) used for precoding the SRSs, or any combination thereof, may be increased by an additional offset when the control signaling triggering the SRSs is received via the cooperative link.

### CROSS REFERENCE

This present Application is a 371 national stage filing of International PCT Application No. PCT/CN2021/115908 by Yuan et al. entitled “TIMING FOR APERIODIC SOUNDING REFERENCE SIGNAL (SRS) TRANSMISSIONS,” filed Sep. 1, 2021, which is assigned to the assignee hereof and which is expressly incorporated by reference in its entirety herein.

### TECHNICAL FIELD

This disclosure relates to wireless communications, including timing for aperiodic sounding reference signal (SRS) transmissions.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

A method for wireless communication at a first user equipment (UE) is described. The method may include establishing a first communication link with a first network entity and a second communication link with a second network entity, where the first communication link between the first UE and the first network entity is via a second UE. The method also may include receiving, from the first network entity via the second UE and the first communication link, control signaling indicating the first UE to transmit one or more sounding reference signals (SRSs). The method further may include transmitting the one or more SRSs at a first time interval from reception of the control signaling at the second UE. The first time interval may be associated with control signaling received from the first network entity via the first communication link, and the first time interval may be different from a second time interval associated with control signaling for SRSs received from the second network entity via the second communication link.

An apparatus for wireless communication at a first UE is described. The apparatus may include a processor, memory coupled with the processor, and instructions stored in the memory. The instructions may be executable by the processor to cause the apparatus to establish a first communication link with a first network entity and a second communication link with a second network entity, where the first communication link between the first UE and the first network entity is via a second UE. The instructions also may be executable by the processor to cause the apparatus to receive, from the first network entity via the second UE and the first communication link, control signaling indicating the first UE to transmit one or more SRSs. The instructions further may be executable by the processor to cause the apparatus to transmit the one or more SRSs at a first time interval from reception of the control signaling at the second UE. The first time interval may be associated with control signaling received from the first network entity via the first communication link, and the first time interval may be different from a second time interval associated with control signaling for SRSs received from the second network entity via the second communication link.

Another apparatus for wireless communication at a first UE is described. The apparatus may include means for establishing a first communication link with a first network entity and a second communication link with a second network entity, where the first communication link between the first UE and the first network entity is via a second UE. The apparatus also may include means for receiving, from the first network entity via the second UE and the first communication link, control signaling indicating the first UE to transmit one or more SRSs. The apparatus further may include means for transmitting the one or more SRSs at a first time interval from reception of the control signaling at the second UE. The first time interval may be associated with control signaling received from the first network entity via the first communication link, and the first time interval may be different from a second time interval associated with control signaling for SRSs received from the second network entity via the second communication link.

A non-transitory computer-readable medium storing code for wireless communication at a first UE is described. The code may include instructions executable by a processor to establish a first communication link with a first network entity and a second communication link with a second network entity, where the first communication link between the first UE and the first network entity is via a second UE. The code also may include instructions executable by the processor to receive, from the first network entity via the second UE and the first communication link, control signaling indicating the first UE to transmit one or more SRSs. The code further may include instructions executable by the processor to transmit the one or more SRSs at a first time interval from reception of the control signaling at the second UE. The first time interval may be associated with control signaling received from the first network entity via the first communication link, and the first time interval may be different from a second time interval associated with control signaling for SRSs received from the second network entity via the second communication link.

In some examples of the method, apparatuses, and non-transitory computer-readable medium described herein, the second network entity may be the first network entity or a different network entity.

In some examples of the method, apparatuses, and non-transitory computer-readable medium described herein, transmitting the one or more SRSs may include operations, features, means, or instructions for transmitting the one or more SRSs at the first time interval, where the first time interval may be greater than or equal to a third time interval starting from reception of the control signaling at the second UE. The third time interval may be associated with control signaling received from the first network entity via the first communication link and including a time interval in which transmission of the one or more SRSs may be restricted.

In some examples of the method, apparatuses, and non-transitory computer-readable medium described herein, the third time interval may be equal to a sum of a first time offset and a fourth time interval in which transmission of the one or more SRSs indicated via the second communication link may be restricted.

Some examples of the method, apparatuses, and non-transitory computer-readable medium described herein may further include operations, features, means, or instructions for receiving an indication of the first time offset, where the third time interval may be determined according to the received indication of the first time offset.

In some examples of the method, apparatuses, and non-transitory computer-readable medium described herein, the first time interval may be equal to a sum of the second time interval and a second time offset. Some examples of the method, apparatuses, and non-transitory computer-readable medium described herein may further include operations, features, means, or instructions for receiving an indication of the second time offset, where the first time interval may be determined according to the received indication of the second time offset.

In some examples of the method, apparatuses, and non-transitory computer-readable medium described herein, the first time interval and the second time interval may be determined according to a same parameter associated with transmission of SRSs, and the first time interval may correspond to a first value of the parameter that may be greater than a second value of the parameter corresponding to the second time interval.

Some examples of the method, apparatuses, and non-transitory computer-readable medium described herein may further include operations, features, means, or instructions for receiving an indication of a maximum value of the parameter, where at least the first value of the parameter may be determined according to the received indication of the maximum value of the parameter.

Some examples of the method, apparatuses, and non-transitory computer-readable medium described herein may further include operations, features, means, or instructions for receiving one or more channel state information reference signals (CSI-RSs) at a fifth time interval from reception of the control signaling at the second UE. The fifth time interval may be identified by the first UE according to the control signaling received from the first network entity via the first communication link, and the fifth time interval may be different from a sixth time interval associated with CSI-RSs received from the second network entity via the second communication link.

Some examples of the method, apparatuses, and non-transitory computer-readable medium described herein may further include operations, features, means, or instructions for receiving an indication of the fifth time interval, where receiving the one or more CSI-RSs may be according to the received indication of the fifth time interval.

A method for wireless communication at a first network entity is described. The method may include establishing a first communication link with a first UE via a second UE, the first communication link different from a second communication link between the first UE and a second network entity. The method also may include transmitting, via the first communication link, control signaling indicating the first UE to transmit one or more SRSs on a set of time resources at a first time interval from transmission of the control signaling. The first time interval may be associated with control signaling transmitted via the first communication link, and the first time interval may be different from a second time interval associated with control signaling for SRSs transmitted by the second network entity via the second communication link.

An apparatus for wireless communication at a first network entity is described. The apparatus may include a processor, memory coupled with the processor, and instructions stored in the memory. The instructions may be executable by the processor to cause the apparatus to establish a first communication link with a first UE via a second UE, the first communication link different from a second communication link between the first UE and a second network entity. The instructions also may be executable by the processor to cause the apparatus to transmit, via the first communication link, control signaling indicating the first UE to transmit one or more SRSs on a set of time resources at a first time interval from transmission of the control signaling. The first time interval may be associated with control signaling transmitted via the first communication link, and the first time interval may be different from a second time interval associated with control signaling for SRSs transmitted by the second network entity via the second communication link.

Another apparatus for wireless communication at a first network entity is described. The apparatus may include means for establishing a first communication link with a first UE via a second UE, the first communication link different from a second communication link between the first UE and a second network entity. The apparatus also may include means for transmitting, via the first communication link, control signaling indicating the first UE to transmit one or more SRSs on a set of time resources at a first time interval from transmission of the control signaling. The first time interval may be associated with control signaling transmitted via the first communication link, and the first time interval may be different from a second time interval associated with control signaling for SRSs transmitted by the second network entity via the second communication link.

A non-transitory computer-readable medium storing code for wireless communication at a first network entity is described. The code may include instructions executable by a processor to establish a first communication link with a first UE via a second UE, the first communication link different from a second communication link between the first UE and a second network entity. The code also may include instructions executable by the processor to transmit, via the first communication link, control signaling indicating the first UE to transmit one or more SRSs on a set of time resources at a first time interval from transmission of the control signaling. The first time interval may be associated with control signaling transmitted via the first communication link, and the first time interval may be different from a second time interval associated with control signaling for SRSs transmitted by the second network entity via the second communication link.

In some examples of the method, apparatuses, and non-transitory computer-readable medium described herein, the second network entity may be the first network entity or a different network entity.

In some examples of the method, apparatuses, and non-transitory computer-readable medium described herein, receiving the one or more SRSs may include operations, features, means, or instructions for receiving, in response to the control signaling, the one or more SRSs on the set of time resources at the first time interval from transmission of the control signaling.

Some examples of the method, apparatuses, and non-transitory computer-readable medium described herein may further include operations, features, means, or instructions for receiving the one or more SRSs at the first time interval, where the first time interval may be greater than or equal to a third time interval starting from transmission of the control signaling via the first communication link. The third time interval may include a time interval in which transmission of the one or more SRSs may be restricted.

In some examples of the method, apparatuses, and non-transitory computer-readable medium described herein, the third time interval may be equal to a sum of a first time offset and a fourth time interval in which transmission of the one or more SRSs indicated via the second communication link may be restricted.

Some examples of the method, apparatuses, and non-transitory computer-readable medium described herein may further include operations, features, means, or instructions for transmitting an indication of the first time offset.

In some examples of the method, apparatuses, and non-transitory computer-readable medium described herein, the first time interval may be equal to a sum of the second time interval and a second time offset.

Some examples of the method, apparatuses, and non-transitory computer-readable medium described herein may further include operations, features, means, or instructions for transmitting an indication of the second time offset.

In some examples of the method, apparatuses, and non-transitory computer-readable medium described herein, the first time interval and the second time interval may be determined according to a same parameter associated with transmission of SRSs, and the first time interval may correspond to a first value of the parameter that may be greater than a second value of the parameter corresponding to the second time interval.

Some examples of the method, apparatuses, and non-transitory computer-readable medium described herein may further include operations, features, means, or instructions for transmitting an indication of a maximum value of the parameter.

Some examples of the method, apparatuses, and non-transitory computer-readable medium described herein may further include operations, features, means, or instructions for transmitting one or more CSI-RSs at a fifth time interval from transmission of the control signaling, the fifth time interval identified according to the control signaling transmitted via the first communication link. The fifth time interval may be different from a sixth time interval associated with CSI-RSs transmitted by the second network entity via the second communication link.

Some examples of the method, apparatuses, and non-transitory computer-readable medium described herein may further include operations, features, means, or instructions for transmitting an indication of the fifth time interval, where transmitting the one or more CSI-RSs may be according to the transmitted indication of the fifth time interval.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a wireless communications system that supports timing for aperiodic sounding reference signal (SRS) transmissions.

FIG. 2 illustrates an example of a signaling diagram that supports timing for aperiodic SRS transmissions.

FIGS. 3A and 3B illustrate examples of timing diagrams that support timing for aperiodic SRS transmissions.

FIG. 4 illustrates an example of a timing diagram that supports timing for aperiodic SRS transmissions.

FIG. 5 illustrates an example of a process flow that supports timing for aperiodic SRS transmissions.

FIG. 6 shows a diagram of an example system including a device that supports timing for aperiodic SRS transmissions.

FIG. 7 shows a diagram of an example system including a device that supports timing for aperiodic SRS transmissions.

FIGS. 8 and 9 show example flowcharts illustrating methods that support timing for aperiodic SRS transmissions.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

In some implementations, a first user equipment (UE) may operate in a cooperative mode with a second UE, with a cooperative link connecting the first UE and the second UE. The cooperative link may, for example, include transmissions from a network entity, for the first UE, where the transmissions may be transmitted to the second UE and relayed to the first UE. In some implementations, some communications via the cooperative link may be delayed due to a time used to relay the communications from the second UE to the first UE. In order to support sounding reference signal (SRS) transmissions within a supported time interval when using a cooperative link, one or more time intervals for SRS transmissions may be selected, ascertained or determined from a type of link (such as the cooperative link or a direct link with the network entity) used to communicate control signaling that triggers SRS transmissions by the first UE. For example, the one or more time intervals for SRS transmissions may be selected, ascertained, or determined when an SRS trigger is received by a UE via a cooperative link or transmitted by a network entity via the cooperative link (for example, instead of or opposed to communicating the SRS trigger via a direct link). The one or more time intervals using the type of link may account for latency that may be introduced by relaying communications via the cooperative link between the two UEs.

In one example, a time interval in which the first UE may not expect to transmit SRSs after receiving the trigger may be increased by an additional offset (relative to SRSs triggered via the direct link) when the SRS trigger is received via the cooperative link. Additionally, or alternatively, a time interval (such as a quantity of slots) between the control signaling and the associated SRSs may be increased by an additional offset (relative to SRSs triggered via the direct link) when the SRS trigger is received via the cooperative link. In some implementations, a time interval between the control signaling and reception of one or more channel state information reference signals (CSI-RSs) used for precoding the SRSs may be increased by an additional offset, such that the one or more CSI-RSs may be received at a closer time to the transmission of the associated SRSs.

Particular implementations of the subject matter described in this disclosure can be implemented to realize one or more of the following potential advantages. For example, by applying one of the additional offsets described herein, a UE and an associated network entity may communicate one or more SRSs within a time interval supported by the UE (for example, according to the latency introduced by the cooperative link). Communication of the one or more SRSs during a supported time interval may increase communication quality, for example, by using one or more parameters selected, ascertained, or determined at the network entity as a result of receiving the one or more SRSs, which may result in a lower probability of missed or undecoded communications from the network entity, or from another network entity. The increased quality of communications may thereby decrease latency and decrease an amount of retransmissions from the network entity to the UE, which may in turn increase throughput for communications between the network entity and the UE, as well as increase battery life at the UE (for example, by attempting to decode less retransmissions).

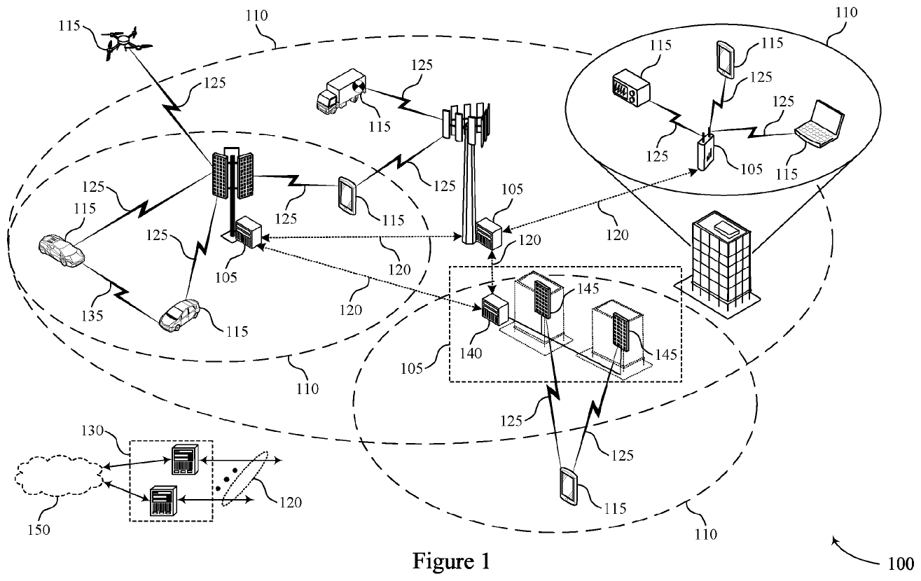

FIG. 1 illustrates an example of a wireless communications system 100 that supports timing for aperiodic SRS transmissions. The wireless communications system 100 may include one or more BSs 105, one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (for example, mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a coverage area 110 over which the UEs 115 and the BS 105 may establish one or more communication links 125. The coverage area 110 may be an example of a geographic area over which a BS 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (for example, core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (for example, via an S1, N2, N3, or another interface). The BSs 105 may communicate with one another over the backhaul links 120 (for example, via an X2, Xn, or another interface) either directly (for example, directly between BSs 105), or indirectly (for example, via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a CA configuration. CA may be used with both frequency division duplexing (FDD) and time division duplexing (TDD) component carriers.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, where the symbol period and subcarrier spacing are inversely related. The quantity of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

The time intervals for the BSs 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some implementations, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some implementations, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (for example, over a carrier) and may be associated with an identifier for distinguishing neighboring cells (for example, a physical cell identifier (PCID), a virtual cell identifier (VCID), or others). In some implementations, a cell also may refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the BS 105. For example, a cell may be or include a building, a subset of a building, or exterior spaces between or overlapping with geographic coverage areas 110, among other implementations.

A macro cell generally covers a relatively large geographic area (for example, several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A BS 105 may support one or multiple cells and also may support communications over the one or more cells using one or multiple component carriers.

In some implementations, a carrier may support multiple cells, and different cells may be configured according to different protocol types (for example, MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (for example, radio heads and ANCs) or consolidated into a single network device (for example, a BS 105). In various implementations, a BS 105, or an access network entity 140, or a core network 130, or a TRP, or some subcomponent thereof, or any combination thereof, may be referred to as a network entity.

As described herein, a BS 105 may include components that are located at a single physical location or components located at various physical locations. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 or a BS 105 including components that are located at various physical locations. In some implementations, such a BS 105 including components that are located at various physical locations may be referred to as or may be associated with a disaggregated radio access network (RAN) architecture, such as an Open RAN (O-RAN) or Virtualized RAN (VRAN) architecture. In some examples, such components of a BS 105 may include or refer to one or more of a central unit (CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be based on a CA configuration in conjunction with component carriers operating in a licensed band (for example, LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (for example, a BS 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer also may use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a BS 105 or a core network 130 supporting radio bearers for user plane data. At the physical layer, transport channels may be mapped to physical channels.

In some implementations, to support SRS transmissions when using a cooperative link, one or more time intervals for SRS transmissions may be selected, ascertained, or determined from a type of link (such as the cooperative link or a direct link with a BS 105) used to communicate control signaling that triggers SRS transmissions at a UE 115. For example, the one or more time intervals for SRS transmissions may be selected, ascertained, or determined when an SRS trigger is received by a UE via a cooperative link or transmitted by a network entity via the cooperative link (for example, instead of or opposed to communicating the SRS trigger via a direct link). Determining the one or more time intervals using the type of link may account for latency that may be introduced by relaying communications via the cooperative link between two UEs 115. In one example, a time interval in which the UE 115 may not expect to transmit SRSs after receiving the trigger may be increased by an additional offset (relative to SRSs triggered via the direct link) when the SRS trigger is received via the cooperative link. Additionally, or alternatively, a time interval (such as a quantity of slots) between the control signaling and the associated SRSs may be increased by an additional offset (relative to SRSs triggered via the direct link) when the SRS trigger is received via the cooperative link.

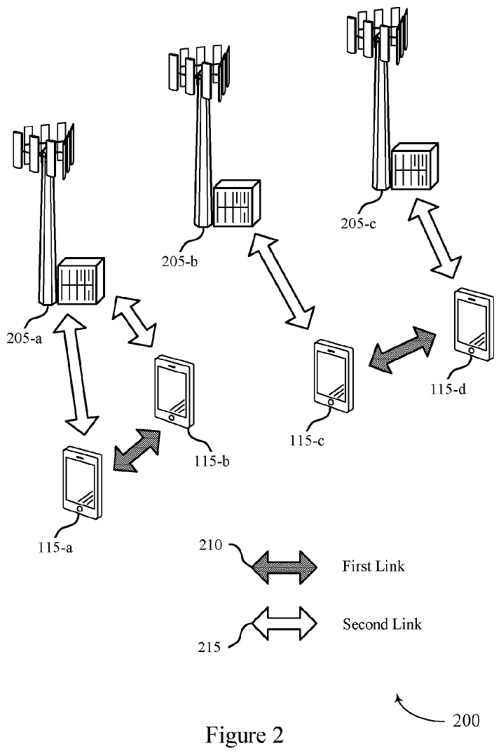

FIG. 2 illustrates an example of a signaling diagram 200 that supports timing for aperiodic SRS transmissions. The signaling diagram 200 may include or implement one or more aspects of the wireless communications system 100. For example, the signaling diagram 200 may include UEs 115-a, 115-b, 115-c, and 115-d, which may each be a respective example of a UE 115 described herein with reference to FIG. 1. Similarly, the signaling diagram 200 may include network entities 205-a, 205-b, and 205-c, which may each be a respective example of a network entity described herein with reference to FIG. 1. For example, as described herein, a network entity 205 may represent a BS, an access network entity, a backhaul network entity, a TRP, or any combination thereof. In some implementations, a network entity 205 as described herein may additionally, or alternatively, represent one or more components of a BS, an access network entity, a backhaul network entity, or a TRP, such as one or more components in a disaggregated RAN (D-RAN) or open RAN (O-RAN) architecture, including CUs, DUs, or RUs, or one or more radio heads or smart radio heads. For example, a network entity 205 may be distributed across, or may represent, one or more network devices as described herein (for example, radio heads and ANCs), or a network entity 205 may be consolidated into a single network device (for example, a BS 105).

One or more of the UEs 115 may operate in an active communication state (may be RRC active) and one or more other UEs 115 may operate in an idle communication state (such as an RRC idle mode). In one example, UEs 115-b and 115-d may represent active UEs 115 and UEs 115-a and 115-c may represent idle UEs 115. In some implementations, data or information throughput to a UE 115 (such as an active UE 115) may be limited by resource under-utilization. For example, the one or more active UEs 115 may be configured to use spatial dimensions (all spatial dimensions) of the network, but an RF capability (such as a number of antennas) of the one or more active UEs 115 may limit throughput (for example, may limit an amount of spatial dimensions useable by the one or more active UEs 115).

In order to utilize available resources more efficiently, such as antennas of the network entities 205, available spatial dimensions, or both, an active UE 115 (such as UE 115-b or UE 115-d) may operate in a UE cooperation mode, or may establish a UE cooperation link (such as a first link 210), with an idle UE 115 (such as UE 115-a or UE 115-c). In such implementations, the UE 115-b or the UE 115-d may be referred to as a target UE 115 or a target device and the idle UE 115 may be referred to as a cooperative UE 115 or a cooperative device. The UE 115-b or the UE 115-d may communicate with a respective network entity 205 (such as the network entity 205-a or 205-b) via the UE 115-a or the UE 115-c, respectively (via a cooperative link or a first link 210), which may increase throughput for the UE 115-b or the UE 115-d. For example, the UE 115-b may establish a cooperative link (such as a first link 210 or a sidelink link) with the UE 115-a, via which the UE 115-b may communicate with the network entity 205-a. Additionally, or alternatively, the UE 115-d may establish a cooperative link (such as a first link 210 or a sidelink link) with the UE 115-c, via which the UE 115-d may communicate with the network entity 205-b. In some implementations, a first link 210 between UEs 115 may utilize unlicensed spectrum, in order to leave licensed spectrum available for network communications.

The UE 115-b or the UE 115-d also may maintain an established connection, or direct link, with a respective network entity 205 (in addition to the cooperative link). For example, the UE 115-b may communicate with the network entity 205-a via a direct link (such as a second link 215) and the UE 115-d may communicate with the network entity 205-c via a direct link (such as a second link 215). Communicating with the network via both of a direct link and a cooperative link may increase throughput at the UE 115-b or the UE 115-d, for example, in comparison with communication via a direct link by itself.

In some implementations, from a perspective of the network (such as from a perspective of the network entity 205-a or the network entity 205-b), the UE 115-a and the UE 115-b, or the UE 115-c and the UE 115-d, may collectively appear, or be viewed as, a single UE 115, which may be referred to as a virtual UE 115 (such as a virtual device). Thus, a virtual UE 115 may be formed by aggregating the UE 115-a and the UE 115-b, or the UE 115-c and the UE 115-d (from the network perspective). In some implementations, the virtual UE 115 may be associated with one or more characteristics of the UE 115-b or the UE 115-d (such as one or more identifiers (IDs), one or more capabilities), such that the network entity 205-a or the network entity 205-b may unknowingly communicate with the UE 115-a or the UE 115-c (for example, the UE 115-a or the UE 115-c may not have a subscription for accessing the network).

For example, in some implementations, the UE 115-a or the UE 115-c may appear to the network or otherwise interact with the network as one or more additional antenna panels of the UE 115-b or the UE 115-d, respectively (for example, beyond a quantity of one or more antenna panels that may be physically included in the UE 115-b or the UE 115-d). In some implementations, each virtual antenna panel (such as each UE 115 of the virtual UE 115) may be associated with a respective TRP, such as in a multi-TRP framework.

In some implementations, because the network may view the UE 115-a and the UE 115-b, or the UE 115-c and the UE 115-d, as a virtual UE 115, a time interval for transmissions from the network entity 205-a or the network entity 205-b, or to the network entity 205-a or 205-c, may not account for latency introduced by the first link 210 between the UEs 115. For example, the network entity 205-a or the network entity 205-b may trigger transmission of SRSs (such as A-SRS) from the UE 115-b or the UE 115-d, respectively (for example, may trigger transmission of the SRSs via the UE 115-a or the UE 115-c, respectively), where the SRS transmissions may be associated with a timer interval that fails to account for latency introduced by relaying the SRS trigger via the first link 210.

When triggering SRSs, the network entity 205-a or the network entity 205-b (such as a TRP) may trigger transmission of the SRSs to itself, or may additionally, or alternatively, trigger transmission of the SRSs to another network entity 205 (such as another TRP, in cross-TRP triggering). For example, the network entity 205-a may trigger transmission of the SRSs from the UE 115-b to the network entity 205-a. Additionally, or alternatively, the network entity 205-b may trigger transmission of the SRSs from the UE 115-d to the network entity 205-c. Such implementations are merely examples, and it is to be understood that any network entity 205 may trigger an SRS transmission to itself, or to another network entity 205. In some implementations, the network entity 205-a or the network entity 205-b may transmit a group common downlink control information (DCI) to trigger the SRSs (for example, may transmit the DCI directly to the UE 115-b or the UE 115-d, or to a cooperative UE 115 for the UE 115-b or the UE 115-d, respectively).

If a DCI (such as control signaling, a group common DCI, a TRP-specific DCI) triggering transmission of the SRSs is transmitted to the UE 115-b or the UE 115-d via the UE 115-a or the UE 115-c, respectively, a first link 210 (such as a UE-to-UE link) may be used to relay the SRS trigger. For example, the UE 115-a or the UE 115-c may receive the DCI triggering the SRSs and may forward the DCI to the UE 115-b or the UE 115-d, respectively. However, the SRS transmission (from the UE 115-b or the UE 115-d to the network entity 205-b or the network entity 205-c, respectively) may be associated with a time interval that fails to account for latency introduced by relaying the triggering DCI via the first link 210. As such, some SRS transmissions may be configured to take place at a time interval in which the UE 115-b or the UE 115-d may be unable to transmit the SRSs (because of the delayed indication of the SRS trigger).

The present disclosure provides techniques to support SRS transmissions within a valid time interval when using a cooperative link for relaying an SRS trigger. For example, the UE 115-b or the UE 115-d, the network entity 205-a or the network entity 205-c (a receiving network entity 205), or both, may select, ascertain, or determine one or more time intervals for SRS transmissions from a type of link (such as cooperative link or direct link) used to communicate control signaling that triggers the SRS transmission. For example, a minimum time interval (in which a UE 115 may be unable to transmit SRSs after receiving the trigger) may be updated by an additional offset when the SRS trigger is communicated via the cooperative link (for example, when the UE 115-b or the UE 115-d, or the network entity 205-a or the network entity 205-c, determines that the SRS trigger is communicated via the cooperative link). Additionally, or alternatively, a time interval (such as a slot) for transmitting the SRSs may be updated by an additional offset, or additional time interval, when the SRS trigger is communicated via the cooperative link.

The UE 115-b or the UE 115-dand the network entity 205-a or the network entity 205-c, respectively, may apply one of the additional offsets described herein, as a result of the SRS trigger being communicated via the cooperative link. For example, the UE 115-b or the UE 115-dand the network entity 205-a or the network entity 205-c, respectively, may apply an additional offset to one or more of the time interval for restriction of SRS transmission, the time interval for transmission of the SRSs, the time interval for transmission of the one or more CSI-RSs, or any combination thereof. By applying the additional offset(s), the UE 115-b or the UE 115-dand the network entity 205-a or the network entity 205-c, respectively, may communicate one or more SRSs within a time interval during which the UE 115-b or the UE 115-dsupports communication of the one or more SRSs (because of the latency introduced by the first link 210).

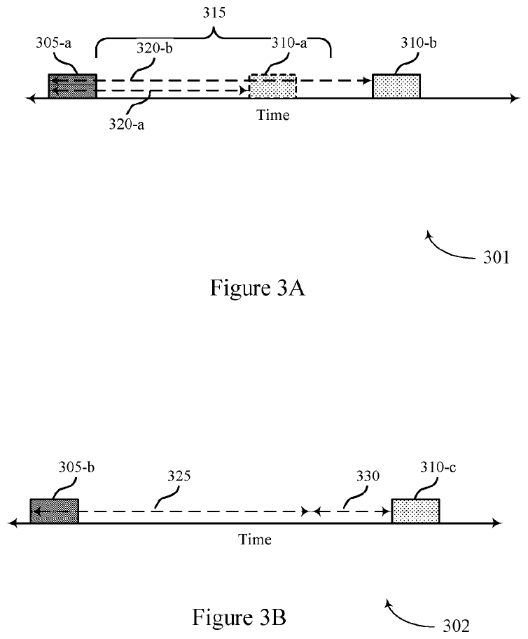

FIG. 3A illustrates an example of a timing diagram 301 that supports timing for aperiodic SRS transmissions. The timing diagram 301 may include or be implemented by one or more aspects of the wireless communications system 100 or the signaling diagram 200. For example, the timing diagram 301 may be implemented by a UE 115, which may be an example of a UE 115 described with reference to FIG. 1 or FIG. 2. Additionally, or alternatively, the timing diagram 301 may be implemented by a network entity 205, which may be an example of a network entity 205 described with reference to FIG. 1 or FIG. 2.

As described with reference to FIG. 2, the UE 115, the network entity 205, or both, may implement one or more timing adjustments for SRS transmissions that are triggered via a cooperative link (relayed by a second UE 115). For example, when the UE 115 is operating in a cooperative mode (for example, with the second UE 115), the network entity 205, or a second network entity 205 (such as a different TRP), may trigger an SRS transmission from the UE 115 to the network entity 205. For example, the network entity 205, or the second network entity 205, may transmit a DCI (such as a downlink DCI, a group common DCI, an uplink DCI based command) to the second UE 115, triggering the SRS transmission from the UE 115. A codepoint of the DCI, for example, may trigger transmission of one or more SRSs 310 (for example, via one or more SRS resource sets) from the UE 115. The second UE 115 may receive the SRS trigger (such as the DCI) and may forward the SRS trigger to the UE 115.

In such implementations, the UE 115, the network entity 205, or both, may apply or count an additional time offset (an offset Tue2ue) for a time interval 315 during which SRS transmissions are restricted at the UE 115 (a time interval 315 during which the UE 115 does not support SRS transmissions). Such an interval may be referred to herein as a minimum, or minimal, time interval. The time interval 315 may be counted from a last symbol (such as a symbol period) of a DCI (such as a physical downlink control channel (PDCCH)) triggering the one or more SRSs and a first symbol of an SRS resource for transmission of the one or more SRSs 310.

The additional time offset of the time interval 315 may be associated with a UE capability (of the UE 115, the second UE 115, or both), which may represent a capability for switching from receiving to transmitting, or for tuning one or more antennas for SRS transmission, among other examples. The additional time offset also may be associated with a latency, or additional signaling time, introduced by a link between the two UEs 115 (such as the cooperative link). The UE 115 may refrain from transmitting SRSs 310 within the time interval 315 and may not expect to receive a DCI triggering an SRS transmission from another UE 115 if a time offset between the DCI (or PDCCH) and the associated one or more SRSs 310 is less than the time interval 315 (minimum time interval or minimum time offset).

For example, the UE 115 may receive control signaling 305-a (such as a DCI) from the network entity 205 or the second network entity 205 (for example, via the second UE 115), which may trigger transmission of one or more SRSs 310. The control signaling 305-a may indicate, or be associated with, a time offset from reception of the control signaling 305-a (at the second UE 115) to transmission of the one or more SRSs 310 (for example, by the UE 115). In a first example, if the time offset is represented by a time offset 320-a, where the time offset 320-a may be less than the time interval 315, the UE 115 may not expect to, or may refrain from, transmitting one or more associated SRSs 310-a. In a second example, if the time offset is represented by a time offset 320-b, where the time offset 320-b may be greater than or equal to the time interval 315, the UE 115 transmit one or more associated SRSs 310-b.

When a triggering DCI (or PDCCH) is received by the second UE 115 and the one or more SRSs 310 are to be transmitted by the UE 115 (a different UE 115 in UE cooperation), the time interval 315 (for example, a minimal time interval) for SRSs 310 in a resource set with usage set to “codebook” or “antennaSwitching” may be represented by a sum of a number of slots (N2), a switching time interval (for example, Tswitch, used by the UE 115 to switch from receiving to transmitting), and the additional time offset (Tue2ue). Similarly, when a triggering DCI (or PDCCH) is received by the second UE 115 and the one or more SRSs 310 are to be transmitted by the UE 115 (a different UE 115 in UE cooperation), the time interval 315 (minimal time interval) for SRSs 310 in another resource set (for example, with usage not set to “codebook” or “antennaSwitching”) may be represented by a sum of a number of slots (N2), a fixed offset (such as 14 slots), and the additional time offset (Tue2ue).

In some implementations, the additional time offset may be indicated dynamically (such as via a DCI or a MAC CE) or semi-statically (such as via RRC signaling). In some other implementations, the additional time offset may be defined or predefined for the UE 115 and the network entity 205 (such as in a wireless communications standard). In some implementations, the additional time offset may have different values for different SRS resource sets, for example, if an SRS resource set has a usage set to “codebook” or “antennaSwitching,” or does not have a usage set to “codebook” or “antennaSwitching.”

The UE 115 and the network entity 205 may apply one of the additional time offsets described herein to select, ascertain, or determine the time interval 315, because the SRS trigger is communicated via the cooperative link. By applying the additional offset, the UE 115 and the network entity 205 may communicate one or more SRSs within a time interval during which the UE 115 supports communication of the one or more SRSs.

FIG. 3B illustrates an example of a timing diagram 302 that supports timing for aperiodic SRS transmissions. The timing diagram 302 may include or be implemented by one or more aspects of the wireless communications system 100 or the signaling diagram 200. For example, the timing diagram 302 may be implemented by a UE 115, which may be an example of a UE 115 described with reference to FIG. 1 or FIG. 2. Additionally, or alternatively, the timing diagram 302 may be implemented by a network entity 205, which may be an example of a network entity 205 described with reference to FIG. 1 or FIG. 2.

As described with reference to FIG. 2, the UE 115, the network entity 205, or both, may implement one or more timing adjustments for SRS transmissions that are triggered via a cooperative link (for example, relayed by a second UE 115). For example, when the UE 115 is operating in a cooperative mode (with the second UE 115), the network entity 205, or a second network entity 205 (such as a different TRP), may trigger an SRS transmission from the UE 115 to the network entity 205. For example, the network entity 205, or the second network entity 205, may transmit a DCI (such as a downlink DCI, a group common DCI, an uplink DCI based command) to the second UE 115, triggering the SRS transmission from the UE 115. A codepoint of the DCI, for example, may trigger transmission of one or more SRSs 310-c (for example, via one or more SRS resource sets) from the UE 115. The second UE 115 may receive the SRS trigger (such as the DCI) and may forward the SRS trigger to the UE 115.

In a first example, the UE 115 may receive control signaling 305-b (such as a DCI) from the network entity 205 or the second network entity 205 (via the second UE 115), which may trigger transmission of the one or more SRSs 310-c. The control signaling 305-b may indicate, or be associated with, a time offset 325 (an offset k) from reception of the control signaling 305-b (at the second UE 115) to transmission of the one or more SRSs 310-c (by the UE 115). In such implementations, the UE 115, the network entity 205, or both, may apply or count an additional time offset 330 (an additional time offset Kₛₗₒₜ^{UE,coop}) to the time offset 325, because the SRS trigger is communicated via the cooperative link (for example, via the second UE 115). The additional time offset 330 may account for, or be associated with, latency due to the cooperative link between the UE 115 and the second UE 115, and may thereby support transmission of the one or more SRSs 310-c at a time in which the UE 115 support SRS transmissions.

For example, if the second UE 115 receives the DCI triggering one or more SRSs (aperiodic SRSs) in a slot (a slot n) for the UE 115 (for example, another UE 115 in UE cooperation), the UE 115 may transmit the associated one or more SRS (for example, every aperiodic SRS resource in each of the triggered SRS resource set(s)) in a slot that may be given by an equation such as Equation (1):

$$⌊ n \cdot \frac{{2}^{μ SRS}}{{2}^{μ PDCCH}} ⌋ + k + {K}_{s l o t}^{UE , coop} \qquad ( 1 )$$

where n represents the slot in which the DCI is received, μSRS represents a subcarrier spacing configuration for the triggered SRS(s), μPDCCH represents a subcarrier spacing configuration for the PDCCH carrying the triggering DCI (such as a triggering command), k represents a number of slots (such as time offset 325) configured via a higher layer parameter (such as slotOffset) for each triggered SRS resource set (and is associated with a subcarrier spacing of the triggered SRS transmission), and Kₛₗₒₜ^{UE,coop} represents the additional time offset 330.

In some implementations, the additional time offset 330 may be indicated dynamically (such as via a DCI or a MAC CE) or semi-statically (such as via RRC signaling). In some other implementations, the additional time offset 330 may be defined or predefined (for example, may have a fixed value) for the UE 115 and the network entity 205 (such as in a wireless communications standard).

In a second example, the UE 115 may receive control signaling 305-b (such as a DCI) from the network entity 205 or the second network entity 205 (via the second UE 115), which may trigger transmission of the one or more SRSs 310-c. The control signaling 305-b may indicate, or be associated with, a time offset 325 (such as a slot offset k) from reception of the control signaling 305-b (at the second UE 115) to transmission of the one or more SRSs 310-c (by the UE 115). In such implementations, the time offset 325 may be extended, for example, as illustrated by an additional time offset 330. For example, if a largest value for k is originally 32 slots, the largest value may be extended to 64 slots or 128 slots. The largest value for k may be configurable, such as via RRC signaling, and may be extended because the SRS trigger is communicated via the cooperative link (for example, via the second UE 115). The extended largest value for k may account for, or be associated with, latency due to the cooperative link between the UE 115 and the second UE 115, and may thereby support transmission of the one or more SRSs 310-c at a time in which the UE 115 support SRS transmissions.

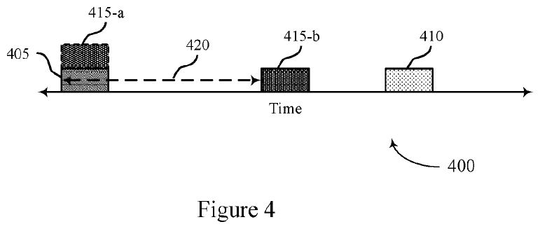

FIG. 4 illustrates an example of a timing diagram 400 that supports timing for aperiodic SRS transmissions. The timing diagram 400 may include or be implemented by one or more aspects of the wireless communications system 100 or the signaling diagram 200. For example, the timing diagram 400 may be implemented by a UE 115, which may be an example of a UE 115 described with reference to FIG. 1 or FIG. 2. Additionally, or alternatively, the timing diagram 400 may be implemented by a network entity 205, which may be an example of a network entity 205 described with reference to FIG. 1 or FIG. 2.

As described with reference to FIG. 2, the UE 115, the network entity 205, or both, may implement one or more timing adjustments for SRS transmissions that are triggered via a cooperative link (relayed by a second UE 115). For example, when the UE 115 is operating in a cooperative mode (with the second UE 115), the network entity 205, or a second network entity 205 (such as a different TRP), may trigger an SRS transmission from the UE 115 to the network entity 205. For example, the network entity 205, or the second network entity 205, may transmit a DCI (such as a downlink DCI, a group common DCI, an uplink DCI based command) to the second UE 115, triggering the SRS transmission from the UE 115. The second UE 115 may receive the SRS trigger (such as the DCI) and may forward the SRS trigger to the UE 115.

For example, the network entity 205, or the second network entity 205, may transmit control signaling 405 (for example, via the cooperative link and the second UE 115), such as a DCI, which may trigger transmission of one or more SRSs 410 from the UE 115. In some implementations (for example, for a set of aperiodic SRSs that is configured for non-codebook uplink MIMO), the UE 115 may receive one or more CSI-RS 415 (such as downlink CSI-RSs) associated with the one or more SRSs 410, which one or more CSI-RSs 415 may be used by the UE 115 to derive uplink precoders for the one or more SRSs 410. For example, if the UE 115 is configured to transmit the one or more SRSs 410 (aperiodic SRS(s)) that are associated with a non-zero power CSI-RS resource (for example, the one or more CSI-RSs 415), a presence of the associated CSI-RS(s) 415 may be indicated by an SRS request filed (such as in the DCI) if the request field value is not ‘00’ and if the scheduling DCI (the control signaling 405) is not used for cross carrier or cross bandwidth scheduling.

In some implementations (such as in a frequency range 1 (FRI)), the associated one or more CSI-RSs 415 (for example, one or more CSI-RSs 415-a) may be communicated in a same slot as the control signaling 405. However, when transmission of the one or more SRSs 410 occurs via the cooperative link (occurs across UEs 115), reception of the one or more CSI-RSs 415 may reduce an accuracy of the precoders derived by the one or more CSI-RSs 415 (for example, because the precoders may be farther in time from the associated one or more SRSs 410).

The present disclosure therefore provides techniques for applying a time offset 420 (a time offset K) between reception of the one or more CSI-RSs 415 (for example, associated with a set of aperiodic SRSs configured for non-codebook uplink MIMO) and the triggering control signaling 405 (such as a PDCCH or DCI). The time offset may apply, for example, when the control signaling 405 and the one or more CSI-RSs 415 are received by different UEs 115 (for example, the control signaling 405 is received by the second UE 115 and forwarded to the UE 115 and the one or more CSI-RSs 415 are received by the UE 115). As such, the one or more CSI-RSs 415 associated with the one or more SRSs 410 may be pushed closer (in time) to the one or more SRSs 410 as represented by one or more CSI-RSs 415-b. By being closer together, an alignment of the one or more CSI-RSs 415-b and the one or more SRSs 410 may increase, such that the precoders derived using the one or more CSI-RSs 415-b (precoders for the one or more SRSs 410) may have an increased accuracy or usability.

The time offset 420 (the time offset K) may be configured by a higher layer parameter (such as a new higher layer parameter, slotoffsetforUEcooperation). Additionally, or alternatively, the time offset 420 may be configured dynamically (such as via a DCI) or may be defined or predefined for the UE 115 (such as by a wireless communications standard and as stored at the UE 115). By using the time offset 420, the associated one or more CSI-RSs 415 (the CSI-RS(s) 415-b) may be located in a slot at the time offset 420 (such as the time offset K) from a slot that carries the SRS request field (for example, in the DCI or control signaling 405 triggering the one or more SRSs 410). The time offset 420 may be greater than zero (K>0) and may be subject to, or associated with, a UE capability for UE cooperation. For example, the UE capability may represent a capability for switching from receiving to transmitting, or for tuning one or more antennas for SRS transmission, or for operating in a cooperative mode with another UE 115, among other examples.

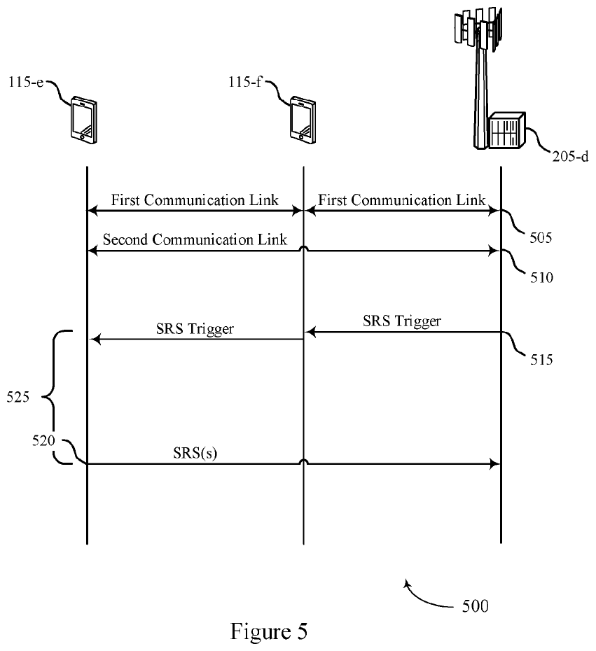

FIG. 5 illustrates an example of a process flow 500 that supports timing for aperiodic SRS transmissions. The process flow 500 may include or be implemented by one or more aspects of the wireless communications system 100 or the signaling diagram 200. For example, the process flow 500 may be implemented by a UE 115-e and a UE 115-f, which may be respective examples of a UE 115 described with reference to FIGS. 1-4. Additionally, the process flow 500 may be implemented by a network entity 205-d, which may be an example of a network entity 205 described with reference to FIGS. 1-4.

In the following description of process flow 500, the operations may be performed in a different order than the order shown, or the operations performed by the UE 115-e, the UE 115-f, and the network entity 205-d may be performed in different orders or at different times. For example, some operations may also be left out of process flow 500, or other operations may be added to process flow 500. Although the UE 115-e, the UE 115-f, and the network entity 205-d are shown performing the operations of process flow 500, some aspects of some operations also may be performed by one or more other wireless devices. For example, some aspects of some operations also may be performed by another, different network entity (another TRP), such as establishing a second communication link and communicating one or more SRSs via the second communication link.

At 505, the UE 115-e and the network entity 205-d may establish a first communication link between the UE 115-e and the network entity 205-d, via the UE 115-f. For example, the first communication link may be referred to herein as a cooperative link.

At 510, the 115-e and the network entity 205-d (or the other network entity, such as a second network entity) may establish a second communication link. For example, the second communication link may be referred to herein as a direct link (such as a direct link between the UE 115-e and the network entity 205-d). In some implementations, the establishment of the first communication link may take place after establishing the second communication link, or may take place at least partially at a same time (at least partially concurrently).

At 515, the network entity 205-d may transmit to the UE 115-e, via the UE 115-f and the first communication link, control signaling indicating the UE 115-e to transmit one or more SRSs. For example, the network entity 205-d may transmit the control signaling to the UE 115-f, via the first communication link, and the UE 115-f may relay the control signaling (or the contents thereof indicating the SRS transmission) to the UE 115-e.

At 520, the UE 115-e may transmit, to the network entity 205-d (or to the other network entity, such as the second network entity) the one or more SRSs at a first time interval 525 from reception of the control signaling at the UE 115-f. The first time interval 525 may be associated with control signaling received from the network entity 205-d via the first communication link. The first time interval 525 also may be different from a second time interval associated with control signaling for SRSs received via the second communication link (for example, from the network entity 205-d or the other network entity). For example, the first time interval 525 may be associated with one or more additional offsets, as described herein.

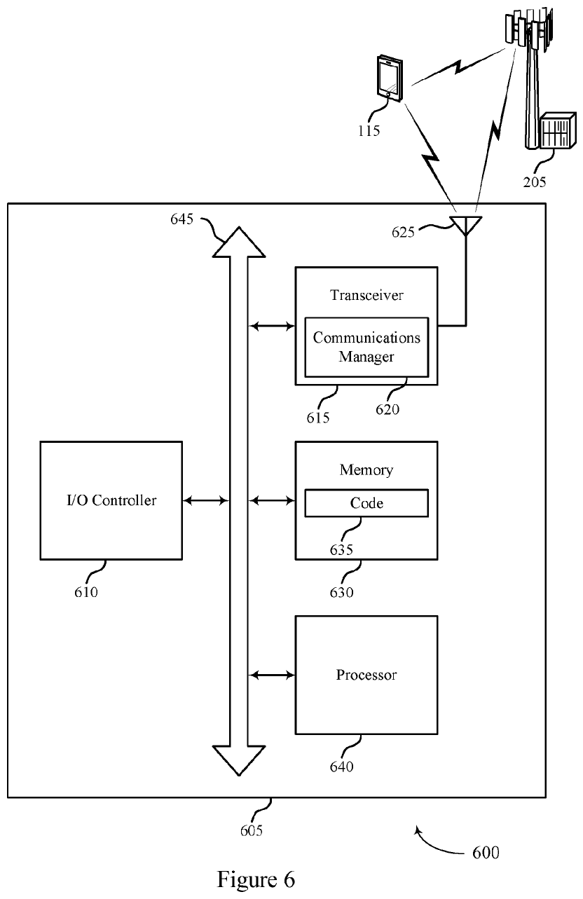

FIG. 6 shows a diagram of an example system 600 including a device 605 that supports timing for aperiodic SRS transmissions. The device 605 may communicate wirelessly with one or more BSs 105, network entities 205, UEs 115, or any combination thereof. The device 605 may include components for bi-directional voice and data communications including components for transmitting and receiving communications, such as a communications manager 620, an input/output (I/O) controller 610, a transceiver 615, an antenna 625, a memory 630, code 635, and a processor 640. These components may be in electronic communication or otherwise coupled (such as operatively, communicatively, functionally, electronically, electrically) via one or more buses (such as a bus 645).

The I/O controller 610 may manage input and output signals for the device 605. The I/O controller 610 also may manage peripherals not integrated into the device 605. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some implementations, the I/O controller 610 may be implemented as part of a processor or processing system, such as the processor 640. In some implementations, a user may interact with the device 605 via the I/O controller 610 or via hardware components controlled by the I/O controller 610.

In some implementations, the device 605 may include a single antenna 625. However, in some other implementations, the device 605 may have more than one antenna 625, which may be capable of concurrently transmitting or receiving multiple wireless transmissions. The transceiver 615 may communicate bi-directionally, via the one or more antennas 625, wired, or wireless links as described herein. For example, the transceiver 615 may represent a wireless transceiver and may communicate bi-directionally with another wireless transceiver. The transceiver 615 also may include a modem to modulate the packets, to provide the modulated packets to one or more antennas 625 for transmission, and to demodulate packets received from the one or more antennas 625. In some implementations, the transceiver 615 may include one or more interfaces, such as one or more interfaces coupled with the one or more antennas 625 that are configured to support various receiving or obtaining operations, or one or more interfaces coupled with the one or more antennas 625 that are configured to support various transmitting or outputting operations, or a combination thereof. In some implementations, the transceiver 615 may include or be configured for coupling with one or more processors or memory components that are operable to perform or support operations based on received or obtained information or signals, or to generate information or other signals for transmission or other outputting, or any combination thereof. In some implementations, the transceiver 615, or the transceiver 615 and the one or more antennas 625, or the transceiver 615 and the one or more antennas 625 and one or more processors or memory components (for example, the processor 640, or the memory 630, or both), may be included in a chip or chip assembly that is installed in the device 605.

The memory 630 may include random access memory (RAM) and read-only memory (ROM). The memory 630 may store computer-readable, computer-executable code 635 including instructions that, when executed by the processor 640, cause the device 605 to perform various functions described herein. The code 635 may be stored in a non-transitory computer-readable medium such as system memory or another type of memory. In some implementations, the code 635 may not be directly executable by the processor 640 but may cause a computer (for example, when compiled and executed) to perform functions described herein. In some implementations, the memory 630 may contain, among other things, a basic I/O system (BIOS) which may control basic hardware or software operation such as the interaction with peripheral components or devices.

The processor 640 may be any one or more suitable processors capable of executing scripts or instructions of one or more software programs stored in the device 605 (such as within the memory 630). In some implementations, the processor 640 may be a component of a processing system. A processing system may generally refer to a system or series of machines or components that receives inputs and processes the inputs to produce a set of outputs (which may be passed to other systems or components of, for example, the device 605). For example, a processing system of the device 605 may refer to a system including the various other components or subcomponents of the device 605, such as the processor 640, or the transceiver 615, or the communications manager 620, or other components or combinations of components of the device 605. The processing system of the device 605 may interface with other components of the device 605, and may process information received from other components (such as inputs or signals) or output information to other components. For example, a chip or modem of the device 605 may include a processing system, a first interface to output information, and a second interface to obtain information. In some implementations, the first interface may refer to an interface between the processing system of the chip or modem and a transmitter, such that the device 605 may transmit information output from the chip or modem. In some implementations, the second interface may refer to an interface between the processing system of the chip or modem and a receiver, such that the device 605 may obtain information or signal inputs, and the information may be passed to the processing system. A person having ordinary skill in the art will readily recognize that the first interface also may obtain information or signal inputs, and the second interface also may output information or signal outputs.

The communications manager 620 may support wireless communication at a first UE 115 in accordance with examples as disclosed herein. For example, the communications manager 620 may be configured as or otherwise support a means for establishing a first communication link with a first network entity 205 and a second communication link with a second network entity, where the first communication link between the first UE 115 and the first network entity 205 is via a second UE 115. The communications manager 620 may be configured as or otherwise support a means for receiving, from the first network entity 205 via the second UE 115 and the first communication link, control signaling indicating the first UE 115 to transmit one or more SRSs. The communications manager 620 may be configured as or otherwise support a means for transmitting the one or more SRSs at a first time interval from reception of the control signaling at the second UE 115. The first time interval may be associated with control signaling received from the first network entity 205 via the first communication link and may be different from a second time interval associated with control signaling for SRSs received from the second network entity via the second communication link.

In some implementations, the second network entity is the first network entity 205 or a different network entity. In some implementations, to support transmitting the one or more SRSs, the communications manager 620 may be configured as or otherwise support a means for transmitting the one or more SRSs at the first time interval. The first time interval may be greater than or equal to a third time interval starting from reception of the control signaling at the second UE 115, and the third time interval may be associated with control signaling received from the first network entity 205 via the first communication link and may include a time interval in which transmission of the one or more SRSs is restricted. In some implementations, the third time interval is equal to a sum of a first time offset and a fourth time interval in which transmission of the one or more SRSs indicated via the second communication link is restricted.

In some implementations, the communications manager 620 may be configured as or otherwise support a means for receiving an indication of the first time offset, where the third time interval is determined according to the received indication of the first time offset. In some implementations, the first time interval is equal to a sum of the second time interval and a second time offset.

In some implementations, the communications manager 620 may be configured as or otherwise support a means for receiving an indication of the second time offset, where the first time interval is determined according to the received indication of the second time offset. In some implementations, the first time interval and the second time interval are determined according to a same parameter associated with transmission of SRSs. In some implementations, the first time interval corresponds to a first value of the parameter that is greater than a second value of the parameter corresponding to the second time interval. In some implementations, the communications manager 620 may be configured as or otherwise support a means for receiving an indication of a maximum value of the parameter, where at least the first value of the parameter is determined according to the received indication of the maximum value of the parameter.

In some implementations, the communications manager 620 may be configured as or otherwise support a means for receiving one or more CSI-RSs at a fifth time interval from reception of the control signaling at the second UE. The fifth time interval may be identified by the first UE 115 according to the control signaling received from the first network entity 205 via the first communication link, and the fifth time interval may be different from a sixth time interval associated with CSI-RSs received from the second network entity via the second communication link. In some implementations, the communications manager 620 may be configured as or otherwise support a means for receiving an indication of the fifth time interval, where receiving the one or more CSI-RSs is according to the received indication of the fifth time interval.

In some implementations, the communications manager 620 may be configured to perform various operations (for example, receiving, monitoring, transmitting) using or otherwise in cooperation with the transceiver 615, the one or more antennas 625, or any combination thereof. Although the communications manager 620 is illustrated as a separate component, in some implementations, one or more functions described with reference to the communications manager 620 may be supported by or performed by the processor 640, the memory 630, the code 635, or any combination thereof. For example, the code 635 may include instructions executable by the processor 640 to cause the device 605 to perform various aspects of timing for aperiodic SRS transmissions as described herein, or the processor 640 and the memory 630 may be otherwise configured to perform or support such operations.

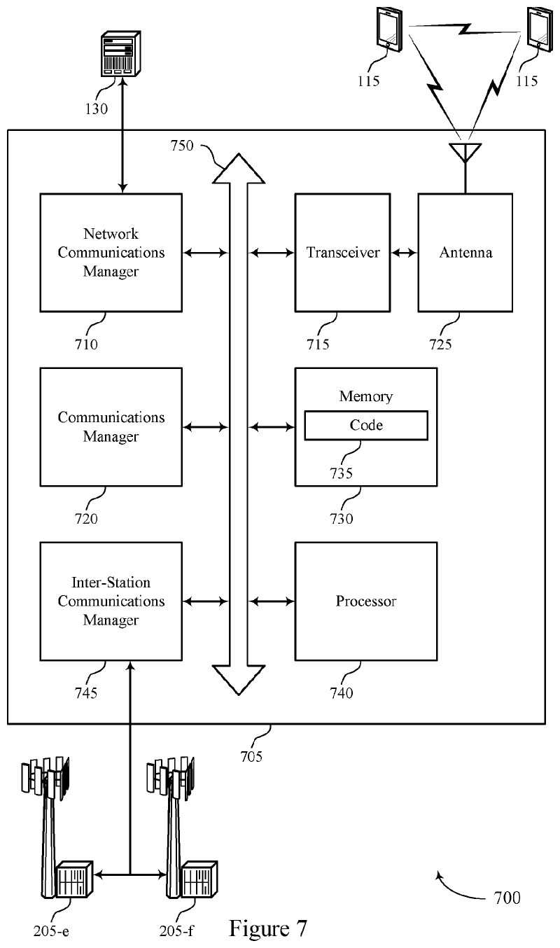

FIG. 7 shows a diagram of an example system 700 including a device 705 that supports timing for aperiodic SRS transmissions. The device 705 (such as a network entity 205) may include components for bi-directional voice and data communications including components for transmitting and receiving communications, such as a communications manager 720, a network communications manager 710, a transceiver 715, an antenna 725, a memory 730, code 735, a processor 740, and an inter-station communications manager 745. These components may be in electronic communication or otherwise coupled (such as operatively, communicatively, functionally, electronically, electrically) via one or more buses (such as a bus 750).

The network communications manager 710 may manage communications with a core network 130 (such as via one or more wired backhaul links). For example, the network communications manager 710 may manage the transfer of data communications for client devices, such as one or more UEs 115.

In some implementations, the device 705 may include a single antenna 725. However, in some other implementations the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 also may include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter or a receiver, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some implementations, the code 735 may not be directly executable by the processor 740 but may cause a computer (such as when compiled and executed) to perform functions described herein. In some implementations, the memory 730 may contain, among other things, a BIOS which may control basic hardware or software operation such as the interaction with peripheral components or devices.

The processor 740 may include an intelligent hardware device (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 740 may be configured to operate a memory array using a memory controller. In some other implementations, a memory controller may be integrated into the processor 740. The processor 740 may be configured to execute computer-readable instructions stored in a memory (such as the memory 730) to cause the device 705 to perform various functions (such as functions or tasks supporting timing for aperiodic SRS transmissions). For example, the device 705 or a component of the device 705 may include a processor 740 and memory 730 coupled to the processor 740, the processor 740 and memory 730 configured to perform various functions described herein.

The inter-station communications manager 745 may manage communications with other BSs 105, and may include a controller or scheduler for controlling communications with UEs 115 in cooperation with other BSs 105. For example, the inter-station communications manager 745 may coordinate scheduling for transmissions to UEs 115 for various interference mitigation techniques such as beamforming or joint transmission. In some examples, the inter-station communications manager 745 may provide an X2 interface within an LTE/LTE-A wireless communications network technology to provide communication between BSs 105.

The communications manager 720 may support wireless communication at a first network entity 205-e in accordance with examples as disclosed herein. For example, the communications manager 720 may be configured as or otherwise support a means for establishing a first communication link with a first UE 115 via a second UE 115, the first communication link different from a second communication link between the first UE 115 and a second network entity 205-f. The communications manager 720 may be configured as or otherwise support a means for transmitting, via the first communication link, control signaling indicating the first UE 115 to transmit one or more SRSs on a set of time resources at a first time interval from transmission of the control signaling. The first time interval may be associated with control signaling transmitted via the first communication link and may be different from a second time interval associated with control signaling for SRSs transmitted by the second network entity 205-f via the second communication link.

In some implementations, the second network entity 205-f is the first network entity 205-e or a different network entity. In some implementations, to support receiving the one or more SRSs, the communications manager 720 may be configured as or otherwise support a means for receiving, in response to the control signaling, the one or more SRSs on the set of time resources at the first time interval from transmission of the control signaling.

In some implementations, the communications manager 720 may be configured as or otherwise support a means for receiving the one or more SRSs at the first time interval. The first time interval may be greater than or equal to a third time interval starting from transmission of the control signaling via the first communication link, and the third time interval may include a time interval in which transmission of the one or more SRSs is restricted. In some implementations, the third time interval is equal to a sum of a first time offset and a fourth time interval in which transmission of the one or more SRSs indicated via the second communication link is restricted. In some implementations, the communications manager 720 may be configured as or otherwise support a means for transmitting an indication of the first time offset. In some implementations, the first time interval is equal to a sum of the second time interval and a second time offset.

In some implementations, the communications manager 720 may be configured as or otherwise support a means for transmitting an indication of the second time offset. In some implementations, the first time interval and the second time interval are determined according to a same parameter associated with transmission of SRSs. In some implementations, the first time interval corresponds to a first value of the parameter that is greater than a second value of the parameter corresponding to the second time interval. In some implementations, the communications manager 720 may be configured as or otherwise support a means for transmitting an indication of a maximum value of the parameter.

In some implementations, the communications manager 720 may be configured as or otherwise support a means for transmitting one or more CSI-RSs at a fifth time interval from transmission of the control signaling. The fifth time interval may be identified according to the control signaling transmitted via the first communication link, and the fifth time interval may be different from a sixth time interval associated with CSI-RSs transmitted by the second network entity 205-f via the second communication link. In some implementations, the communications manager 720 may be configured as or otherwise support a means for transmitting an indication of the fifth time interval, where transmitting the one or more CSI-RSs is according to the transmitted indication of the fifth time interval.

In some implementations, the communications manager 720 may be configured to perform various operations (such as receiving, monitoring, transmitting) using or otherwise in cooperation with the transceiver 715, the one or more antennas 725, or any combination thereof. Although the communications manager 720 is illustrated as a separate component, in some implementations, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of timing for aperiodic SRS transmissions as described herein, or the processor 740 and the memory 730 may be otherwise configured to perform or support such operations.

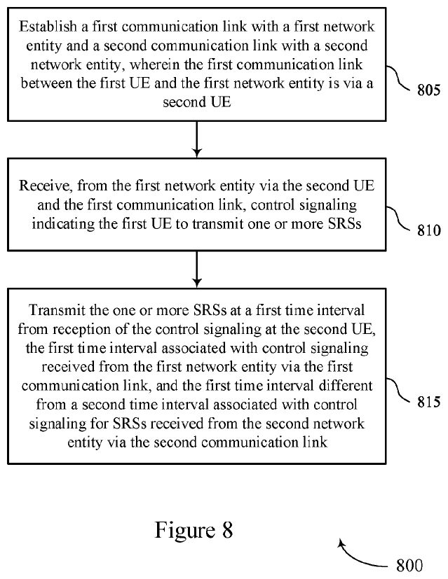

FIG. 8 shows an example flowchart illustrating a method 800 that supports timing for aperiodic SRS transmissions. The operations of the method 800 may be implemented by a UE 115 or its components as described herein. For example, the operations of the method 800 may be performed by a UE 115 as described with reference to FIGS. 1-6. In some implementations, a UE 115 may execute a set of instructions to control the functional elements of the UE 115 to perform the described functions. Additionally, or alternatively, the UE 115 may perform aspects of the described functions using special-purpose hardware.

At 805, the method may include establishing a first communication link with a first network entity and a second communication link with a second network entity, where the first communication link between the first UE 115 and the first network entity is via a second UE 115. The operations of 805 may be performed in accordance with examples as disclosed herein.

At 810, the method may include receiving, from the first network entity via the second UE 115 and the first communication link, control signaling indicating the first UE 115 to transmit one or more SRSs. The operations of 810 may be performed in accordance with examples as disclosed herein.

At 815, the method may include transmitting the one or more SRSs at a first time interval from reception of the control signaling at the second UE 115. The first time interval may be associated with control signaling received from the first network entity via the first communication link and may be different from a second time interval associated with control signaling for SRSs received from the second network entity via the second communication link. The operations of 815 may be performed in accordance with examples as disclosed herein.

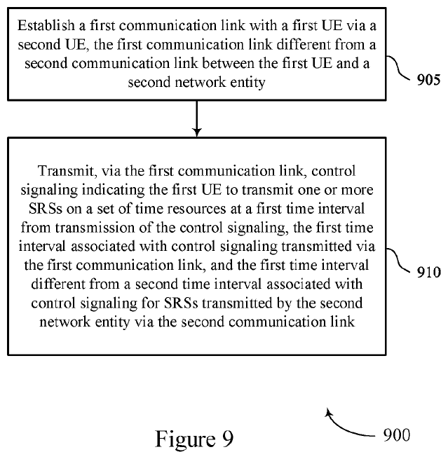

FIG. 9 shows an example flowchart illustrating a method 900 that supports timing for aperiodic SRS transmissions. The operations of the method 900 may be implemented by a network entity or its components as described herein. For example, the operations of the method 900 may be performed by a network entity as described with reference to FIGS. 1-4 and 7. In some implementations, a network entity may execute a set of instructions to control the functional elements of the network entity to perform the described functions. Additionally, or alternatively, the network entity may perform aspects of the described functions using special-purpose hardware.

At 905, the method may include establishing a first communication link with a first UE 115 via a second UE 115, the first communication link different from a second communication link between the first UE 115 and a second network entity. The operations of 905 may be performed in accordance with examples as disclosed herein.

At 910, the method may include transmitting, via the first communication link, control signaling indicating the first UE 115 to transmit one or more SRSs on a set of time resources at a first time interval from transmission of the control signaling. The first time interval may be associated with control signaling transmitted via the first communication link and may be different from a second time interval associated with control signaling for SRSs transmitted by the second network entity via the second communication link. The operations of 910 may be performed in accordance with examples as disclosed herein.

The following provides an overview of some aspects of the present disclosure:

Aspect 1: An apparatus for wireless communication at a first UE, including: a processor; memory coupled with the processor; and instructions stored in the memory and executable by the processor to cause the apparatus to: establish a first communication link with a first network entity and a second communication link with a second network entity, where the first communication link between the first UE and the first network entity is via a second UE; receive, from the first network entity via the second UE and the first communication link, control signaling indicating the first UE to transmit one or more SRSs; and transmit the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

Aspect 2: The apparatus of aspect 1, where the second network entity is the first network entity or a different network entity.

Aspect 3: The apparatus of any of aspects 1 through 2, where the instructions are further executable by the processor to cause the apparatus to: transmit the one or more SRSs at the first time interval, where the first time interval is greater than or equal to a third time interval starting from reception of the control signaling at the second UE, the third time interval associated with control signaling received from the first network entity via the first communication link and including a time interval in which transmission of the one or more SRSs is restricted.

Aspect 4: The apparatus of aspect 3, where the third time interval is equal to a sum of a first time offset and a fourth time interval in which transmission of the one or more SRSs indicated via the second communication link is restricted.

Aspect 5: The apparatus of aspect 4, where the instructions are further executable by the processor to cause the apparatus to: receive an indication of the first time offset, where the third time interval is determined according to the received indication of the first time offset.

Aspect 6: The apparatus of any of aspects 1 through 5, where the first time interval is equal to a sum of the second time interval and a second time offset.

Aspect 7: The apparatus of aspect 6, where the instructions are further executable by the processor to cause the apparatus to: receive an indication of the second time offset, where the first time interval is determined according to the received indication of the second time offset.

Aspect 8: The apparatus of any of aspects 1 through 5, where the first time interval and the second time interval are determined according to a same parameter associated with transmission of SRSs, and the first time interval corresponds to a first value of the parameter that is greater than a second value of the parameter corresponding to the second time interval.

Aspect 9: The apparatus of aspect 8, where the instructions are further executable by the processor to cause the apparatus to: receive an indication of a maximum value of the parameter, where at least the first value of the parameter is determined according to the received indication of the maximum value of the parameter.

Aspect 10: The apparatus of any of aspects 1 through 9, where the instructions are further executable by the processor to cause the apparatus to: receive one or more CSI-RSs at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

Aspect 11: The apparatus of aspect 10, where the instructions are further executable by the processor to cause the apparatus to: receive an indication of the fifth time interval, where receive the one or more CSI-RSs is according to the received indication of the fifth time interval.

Aspect 12: An apparatus for wireless communication at a first network entity, including: a processor; memory coupled with the processor; and instructions stored in the memory and executable by the processor to cause the apparatus to: establish a first communication link with a first UE via a second UE, the first communication link different from a second communication link between the first UE and a second network entity; and transmit, via the first communication link, control signaling indicating the first UE to transmit one or more SRSs on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

Aspect 13: The apparatus of aspect 12, where the second network entity is the first network entity or a different network entity.

Aspect 14: The apparatus of any of aspects 12 through 13, where the instructions are further executable by the processor to cause the apparatus to: receive, in response to the control signaling, the one or more SRSs on the set of time resources at the first time interval from transmission of the control signaling.

Aspect 15: The apparatus of any of aspects 12 through 14, where the instructions are further executable by the processor to cause the apparatus to: receive the one or more SRSs at the first time interval, where the first time interval is greater than or equal to a third time interval starting from transmission of the control signaling via the first communication link, the third time interval including a time interval in which transmission of the one or more SRSs is restricted.

Aspect 16: The apparatus of aspect 15, where the third time interval is equal to a sum of a first time offset and a fourth time interval in which transmission of the one or more SRSs indicated via the second communication link is restricted.

Aspect 17: The apparatus of aspect 16, where the instructions are further executable by the processor to cause the apparatus to: transmit an indication of the first time offset.

Aspect 18: The apparatus of any of aspects 12 through 17, where the first time interval is equal to a sum of the second time interval and a second time offset.

Aspect 19: The apparatus of aspect 18, where the instructions are further executable by the processor to cause the apparatus to: transmit an indication of the second time offset.

Aspect 20: The apparatus of any of aspects 12 through 17, where the first time interval and the second time interval are determined according to a same parameter associated with transmission of SRSs, and the first time interval corresponds to a first value of the parameter that is greater than a second value of the parameter corresponding to the second time interval.

Aspect 21: The apparatus of aspect 20, where the instructions are further executable by the processor to cause the apparatus to: transmit an indication of a maximum value of the parameter.

Aspect 22: The apparatus of any of aspects 12 through 21, where the instructions are further executable by the processor to cause the apparatus to: transmit one or more CSI-RSs at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.

Aspect 23: The apparatus of aspect 22, where the instructions are further executable by the processor to cause the apparatus to: transmit an indication of the fifth time interval, where transmit the one or more CSI-RSs is according to the transmitted indication of the fifth time interval.

Aspect 24: A method for wireless communication at a first UE, including: establishing a first communication link with a first network entity and a second communication link with a second network entity, where the first communication link between the first UE and the first network entity is via a second UE; receiving, from the first network entity via the second UE and the first communication link, control signaling indicating the first UE to transmit one or more SRSs; and transmitting the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

Aspect 25: The method of aspect 24, where the second network entity is the first network entity or a different network entity.

Aspect 26: The method of any of aspects 24 through 25, where transmitting the one or more SRSs includes: transmitting the one or more SRSs at the first time interval, where the first time interval is greater than or equal to a third time interval starting from reception of the control signaling at the second UE, the third time interval associated with control signaling received from the first network entity via the first communication link and including a time interval in which transmission of the one or more SRSs is restricted.

Aspect 27: The method of aspect 26, where the third time interval is equal to a sum of a first time offset and a fourth time interval in which transmission of the one or more SRSs indicated via the second communication link is restricted.

Aspect 28: The method of aspect 27, further including: receiving an indication of the first time offset, where the third time interval is determined according to the received indication of the first time offset.

Aspect 29: The method of any of aspects 24 through 28, where the first time interval is equal to a sum of the second time interval and a second time offset.

Aspect 30: The method of aspect 29, further including: receiving an indication of the second time offset, where the first time interval is determined according to the received indication of the second time offset.

Aspect 31: The method of any of aspects 24 through 28, where the first time interval and the second time interval are determined according to a same parameter associated with transmission of SRSs, and the first time interval corresponds to a first value of the parameter that is greater than a second value of the parameter corresponding to the second time interval.

Aspect 32: The method of aspect 31, further including: receiving an indication of a maximum value of the parameter, where at least the first value of the parameter is determined according to the received indication of the maximum value of the parameter.

Aspect 33: The method of any of aspects 24 through 32, further including: receiving one or more CSI-RSs at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

Aspect 34: The method of aspect 33, further including: receiving an indication of the fifth time interval, where receiving the one or more CSI-RSs is according to the received indication of the fifth time interval.

Aspect 35: A method for wireless communication at a first network entity, including: establishing a first communication link with a first UE via a second UE, the first communication link different from a second communication link between the first UE and a second network entity; and transmitting, via the first communication link, control signaling indicating the first UE to transmit one or more SRSs on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

Aspect 36: The method of aspect 35, where the second network entity is the first network entity or a different network entity.

Aspect 37: The method of any of aspects 35 through 36, where receiving the one or more SRSs includes: receiving, in response to the control signaling, the one or more SRSs on the set of time resources at the first time interval from transmission of the control signaling.

Aspect 38: The method of any of aspects 35 through 37, further including: receiving the one or more SRSs at the first time interval, where the first time interval is greater than or equal to a third time interval starting from transmission of the control signaling via the first communication link, the third time interval including a time interval in which transmission of the one or more SRSs is restricted.

Aspect 39: The method of aspect 38, where the third time interval is equal to a sum of a first time offset and a fourth time interval in which transmission of the one or more SRSs indicated via the second communication link is restricted.

Aspect 40: The method of aspect 39, further including: transmitting an indication of the first time offset.

Aspect 41: The method of any of aspects 35 through 40, where the first time interval is equal to a sum of the second time interval and a second time offset.

Aspect 42: The method of aspect 18, further including: transmitting an indication of the second time offset.

Aspect 43: The method of any of aspects 35 through 40, where the first time interval and the second time interval are determined according to a same parameter associated with transmission of SRSs, and the first time interval corresponds to a first value of the parameter that is greater than a second value of the parameter corresponding to the second time interval.

Aspect 44: The method of aspect 43, further including: transmitting an indication of a maximum value of the parameter.

Aspect 45: The method of any of aspects 35 through 44, further including: transmitting one or more CSI-RSs at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.

Aspect 46: The method of aspect 45, further including: transmitting an indication of the fifth time interval, where transmitting the one or more CSI-RSs is according to the transmitted indication of the fifth time interval.

Aspect 47: An apparatus for wireless communication at a first UE, including: means for establishing a first communication link with a first network entity and a second communication link with a second network entity, where the first communication link between the first UE and the first network entity is via a second UE; means for receiving, from the first network entity via the second UE and the first communication link, control signaling indicating the first UE to transmit one or more SRSs; and means for transmitting the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

Aspect 48: The apparatus of aspect 47, where the second network entity is the first network entity or a different network entity.

Aspect 49: The apparatus of any of aspects 47 through 48, where the apparatus further includes: means for transmitting the one or more SRSs at the first time interval, where the first time interval is greater than or equal to a third time interval starting from reception of the control signaling at the second UE, the third time interval associated with control signaling received from the first network entity via the first communication link and including a time interval in which transmission of the one or more SRSs is restricted.

Aspect 50: The apparatus of aspect 49, where the third time interval is equal to a sum of a first time offset and a fourth time interval in which transmission of the one or more SRSs indicated via the second communication link is restricted.

Aspect 51: The apparatus of aspect 50, where the apparatus further includes: means for receiving an indication of the first time offset, where the third time interval is determined according to the received indication of the first time offset.

Aspect 52: The apparatus of any of aspects 47 through 51, where the first time interval is equal to a sum of the second time interval and a second time offset.

Aspect 53: The apparatus of aspect 52, where the apparatus further includes: means for receiving an indication of the second time offset, where the first time interval is determined according to the received indication of the second time offset.

Aspect 54: The apparatus of any of aspects 47 through 51, where the first time interval and the second time interval are determined according to a same parameter associated with transmission of SRSs, and the first time interval corresponds to a first value of the parameter that is greater than a second value of the parameter corresponding to the second time interval.

Aspect 55: The apparatus of aspect 54, where the apparatus further includes: means for receiving an indication of a maximum value of the parameter, where at least the first value of the parameter is determined according to the received indication of the maximum value of the parameter.

Aspect 56: The apparatus of any of aspects 47 through 55, where the apparatus further includes: means for receiving one or more CSI-RSs at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

Aspect 57: The apparatus of aspect 56, where the apparatus further includes: means for receiving an indication of the fifth time interval, where receiving the one or more CSI-RSs is according to the received indication of the fifth time interval.

Aspect 58: An apparatus for wireless communication at a first network entity, including: means for establishing a first communication link with a first UE via a second UE, the first communication link different from a second communication link between the first UE and a second network entity; and means for transmitting, via the first communication link, control signaling indicating the first UE to transmit one or more SRSs on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

Aspect 59: The apparatus of aspect 58, where the second network entity is the first network entity or a different network entity.

Aspect 60: The apparatus of any of aspects 58 through 59, where the apparatus further includes: means for receiving, in response to the control signaling, the one or more SRSs on the set of time resources at the first time interval from transmission of the control signaling.

Aspect 61: The apparatus of any of aspects 58 through 60, where the apparatus further includes: means for receiving the one or more SRSs at the first time interval, where the first time interval is greater than or equal to a third time interval starting from transmission of the control signaling via the first communication link, the third time interval including a time interval in which transmission of the one or more SRSs is restricted.

Aspect 62: The apparatus of aspect 61, where the third time interval is equal to a sum of a first time offset and a fourth time interval in which transmission of the one or more SRSs indicated via the second communication link is restricted.

Aspect 63: The apparatus of aspect 62, where the apparatus further includes: means for transmitting an indication of the first time offset.

Aspect 64: The apparatus of any of aspects 58 through 63, where the first time interval is equal to a sum of the second time interval and a second time offset.

Aspect 65: The apparatus of aspect 64, where the apparatus further includes: means for transmitting an indication of the second time offset.

Aspect 66: The apparatus of any of aspects 58 through 63, where the first time interval and the second time interval are determined according to a same parameter associated with transmission of SRSs, and the first time interval corresponds to a first value of the parameter that is greater than a second value of the parameter corresponding to the second time interval.

Aspect 67: The apparatus of aspect 66, where the apparatus further includes: means for transmitting an indication of a maximum value of the parameter.

Aspect 68: The apparatus of any of aspects 58 through 67, where the apparatus further includes: means for transmitting one or more CSI-RSs at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.

Aspect 69: The apparatus of aspect 68, where the apparatus further includes: means for transmitting an indication of the fifth time interval, where transmitting the one or more CSI-RSs is according to the transmitted indication of the fifth time interval.

Aspect 70: A non-transitory computer-readable medium storing code for wireless communication at a first UE, where the code includes instructions executable by a processor to: establish a first communication link with a first network entity and a second communication link with a second network entity, where the first communication link between the first UE and the first network entity is via a second UE; receive, from the first network entity via the second UE and the first communication link, control signaling indicating the first UE to transmit one or more SRSs; and transmit the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

Aspect 71: The non-transitory computer-readable medium of aspect 70, where the second network entity is the first network entity or a different network entity.

Aspect 72: The non-transitory computer-readable medium of any of aspects 70 through 2, where the code further includes instructions executable by a processor to: transmit the one or more SRSs at the first time interval, where the first time interval is greater than or equal to a third time interval starting from reception of the control signaling at the second UE, the third time interval associated with control signaling received from the first network entity via the first communication link and including a time interval in which transmission of the one or more SRSs is restricted.

Aspect 73: The non-transitory computer-readable medium of aspect 72, where the third time interval is equal to a sum of a first time offset and a fourth time interval in which transmission of the one or more SRSs indicated via the second communication link is restricted.

Aspect 74: The non-transitory computer-readable medium of aspect 73, where the code further includes instructions executable by a processor to: receive an indication of the first time offset, where the third time interval is determined according to the received indication of the first time offset.

Aspect 75: The non-transitory computer-readable medium of any of aspects 70 through 74, where the first time interval is equal to a sum of the second time interval and a second time offset.

Aspect 76: The non-transitory computer-readable medium of aspect 75, where the code further includes instructions executable by a processor to: receive an indication of the second time offset, where the first time interval is determined according to the received indication of the second time offset.

Aspect 77: The non-transitory computer-readable medium of any of aspects 70 through 74, where the first time interval and the second time interval are determined according to a same parameter associated with transmission of SRSs, and the first time interval corresponds to a first value of the parameter that is greater than a second value of the parameter corresponding to the second time interval.

Aspect 78: The non-transitory computer-readable medium of aspect 77, where the code further includes instructions executable by a processor to: receive an indication of a maximum value of the parameter, where at least the first value of the parameter is determined according to the received indication of the maximum value of the parameter.

Aspect 79: The non-transitory computer-readable medium of any of aspects 70 through 78, where the code further includes instructions executable by a processor to: receive one or more CSI-RSs at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

Aspect 80: The non-transitory computer-readable medium of aspect 79, where the code further includes instructions executable by a processor to: receive an indication of the fifth time interval, where receive the one or more CSI-RSs is according to the received indication of the fifth time interval.

Aspect 81: A non-transitory computer-readable medium storing code for wireless communication at a first network entity, where the code includes instructions executable by a processor to: establish a first communication link with a first UE via a second UE, the first communication link different from a second communication link between the first UE and a second network entity; and transmit, via the first communication link, control signaling indicating the first UE to transmit one or more SRSs on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

Aspect 82: The non-transitory computer-readable medium of aspect 81, where the second network entity is the first network entity or a different network entity.

Aspect 83: The non-transitory computer-readable medium of any of aspects 81 through 82, where the code further includes instructions executable by a processor to: receive, in response to the control signaling, the one or more SRSs on the set of time resources at the first time interval from transmission of the control signaling.

Aspect 84: The non-transitory computer-readable medium of any of aspects 81 through 83, where the code further includes instructions executable by a processor to: receive the one or more SRSs at the first time interval, where the first time interval is greater than or equal to a third time interval starting from transmission of the control signaling via the first communication link, the third time interval including a time interval in which transmission of the one or more SRSs is restricted.

Aspect 85: The non-transitory computer-readable medium of aspect 84, where the third time interval is equal to a sum of a first time offset and a fourth time interval in which transmission of the one or more SRSs indicated via the second communication link is restricted.

Aspect 86: The non-transitory computer-readable medium of aspect 85, where the code further includes instructions executable by a processor to: transmit an indication of the first time offset.

Aspect 87: The non-transitory computer-readable medium of any of aspects 81 through 86, where the first time interval is equal to a sum of the second time interval and a second time offset.

Aspect 88: The non-transitory computer-readable medium of aspect 87, where the code further includes instructions executable by a processor to: transmit an indication of the second time offset.

Aspect 89: The non-transitory computer-readable medium of any of aspects 81 through 86, where the first time interval and the second time interval are determined according to a same parameter associated with transmission of SRSs, and the first time interval corresponds to a first value of the parameter that is greater than a second value of the parameter corresponding to the second time interval.

Aspect 90: The non-transitory computer-readable medium of aspect 89, where the code further includes instructions executable by a processor to: transmit an indication of a maximum value of the parameter.

Aspect 91: The non-transitory computer-readable medium of any of aspects 81 through 90, where the code further includes instructions executable by a processor to: transmit one or more CSI-RSs at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.

Aspect 92: The non-transitory computer-readable medium of aspect 91, where the code further includes instructions executable by a processor to: transmit an indication of the fifth time interval, where transmit the one or more CSI-RSs is according to the transmitted indication of the fifth time interval.

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a first user equipment (UE), comprising:
a processor;
memory coupled with the processor; and
instructions stored in the memory and executable by the processor to cause the apparatus to:
establish a first communication link with a first network entity and a second communication link with a second network entity, wherein the first communication link between the first UE and the first network entity is via a second UE;
receive, from the first network entity via the second UE and the first communication link, control signaling indicating the first UE to transmit one or more sounding reference signals (SRSs); and
transmit the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

2. The apparatus of claim 1, wherein the second network entity is the first network entity or a different network entity.

3. The apparatus of claim 1, wherein the instructions are further executable by the processor to cause the apparatus to:
transmit the one or more SRSs at the first time interval, wherein the first time interval is greater than or equal to a third time interval starting from reception of the control signaling at the second UE, the third time interval associated with control signaling received from the first network entity via the first communication link and comprising a time interval in which transmission of the one or more SRSs is restricted.

4. The apparatus of claim 3, wherein the third time interval is equal to a sum of a first time offset and a fourth time interval in which transmission of the one or more SRSs indicated via the second communication link is restricted.

5. The apparatus of claim 4, wherein the instructions are further executable by the processor to cause the apparatus to:
receive an indication of the first time offset, wherein the third time interval is determined according to the received indication of the first time offset.

6. The apparatus of claim 1, wherein the first time interval is equal to a sum of the second time interval and a second time offset.

7. The apparatus of claim 6, wherein the instructions are further executable by the processor to cause the apparatus to:
receive an indication of the second time offset, wherein the first time interval is determined according to the received indication of the second time offset.

8. The apparatus of claim 1, wherein:
the first time interval and the second time interval are determined according to a same parameter associated with transmission of SRSs, and
the first time interval corresponds to a first value of the parameter that is greater than a second value of the parameter corresponding to the second time interval.

9. The apparatus of claim 8, wherein the instructions are further executable by the processor to cause the apparatus to:
receive an indication of a maximum value of the parameter, wherein at least the first value of the parameter is determined according to the received indication of the maximum value of the parameter.

10. The apparatus of claim 1, wherein the instructions are further executable by the processor to cause the apparatus to:
receive one or more channel state information reference signals (CSI-RSs) at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

11. The apparatus of claim 10, wherein the instructions are further executable by the processor to cause the apparatus to:
receive an indication of the fifth time interval, wherein receiving the one or more CSI-RSs is according to the received indication of the fifth time interval.

12. An apparatus for wireless communication at a first network entity, comprising:
a processor;
memory coupled with the processor; and
instructions stored in the memory and executable by the processor to cause the apparatus to:
establish a first communication link with a first user equipment (UE) via a second UE, the first communication link different from a second communication link between the first UE and a second network entity; and
transmit, via the first communication link, control signaling indicating the first UE to transmit one or more sounding reference signals (SRSs) on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

13. The apparatus of claim 12, wherein the second network entity is the first network entity or a different network entity.

14. The apparatus of claim 12, wherein the instructions are further executable by the processor to cause the apparatus to:
receive, in response to the control signaling, the one or more SRSs on the set of time resources at the first time interval from transmission of the control signaling.

15. The apparatus of claim 12, wherein the instructions are further executable by the processor to cause the apparatus to:
receive the one or more SRSs at the first time interval, wherein the first time interval is greater than or equal to a third time interval starting from transmission of the control signaling via the first communication link, the third time interval comprising a time interval in which transmission of the one or more SRSs is restricted.

16. The apparatus of claim 15, wherein the third time interval is equal to a sum of a first time offset and a fourth time interval in which transmission of the one or more SRSs indicated via the second communication link is restricted.

17. The apparatus of claim 16, wherein the instructions are further executable by the processor to cause the apparatus to:
transmit an indication of the first time offset.

18. The apparatus of claim 12, wherein the first time interval is equal to a sum of the second time interval and a second time offset.

19. The apparatus of claim 18, wherein the instructions are further executable by the processor to cause the apparatus to:
transmit an indication of the second time offset.

20. The apparatus of claim 12, wherein:
the first time interval and the second time interval are determined according to a same parameter associated with transmission of SRSs, and
the first time interval corresponds to a first value of the parameter that is greater than a second value of the parameter corresponding to the second time interval.

21. The apparatus of claim 20, wherein the instructions are further executable by the processor to cause the apparatus to:
transmit an indication of a maximum value of the parameter.

22. The apparatus of claim 12, wherein the instructions are further executable by the processor to cause the apparatus to:
transmit one or more channel state information reference signals (CSI-RSs) at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.

23. The apparatus of claim 22, wherein the instructions are further executable by the processor to cause the apparatus to:
transmit an indication of the fifth time interval, wherein transmitting the one or more CSI-RSs is according to the transmitted indication of the fifth time interval.

24. A method for wireless communication at a first user equipment (UE), comprising:
establishing a first communication link with a first network entity and a second communication link with a second network entity, wherein the first communication link between the first UE and the first network entity is via a second UE;
receiving, from the first network entity via the second UE and the first communication link, control signaling indicating the first UE to transmit one or more sounding reference signals (SRSs); and
transmitting the one or more SRSs at a first time interval from reception of the control signaling at the second UE, the first time interval associated with control signaling received from the first network entity via the first communication link, and the first time interval different from a second time interval associated with control signaling for SRSs received from the second network entity via the second communication link.

25. The method of claim 24, wherein transmitting the one or more SRSs comprises:
transmitting the one or more SRSs at the first time interval, wherein the first time interval is greater than or equal to a third time interval starting from reception of the control signaling at the second UE, the third time interval associated with control signaling received from the first network entity via the first communication link and comprising a time interval in which transmission of the one or more SRSs is restricted.

26. The method of claim 24, further comprising:
receiving one or more channel state information reference signals (CSI-RSs) at a fifth time interval from reception of the control signaling at the second UE, the fifth time interval identified by the first UE according to the control signaling received from the first network entity via the first communication link, and the fifth time interval different from a sixth time interval associated with CSI-RSs received from the second network entity via the second communication link.

27. A method for wireless communication at a first network entity, comprising:
establishing a first communication link with a first user equipment (UE) via a second UE, the first communication link different from a second communication link between the first UE and a second network entity; and
transmitting, via the first communication link, control signaling indicating the first UE to transmit one or more sounding reference signals (SRSs) on a set of time resources at a first time interval from transmission of the control signaling, the first time interval associated with control signaling transmitted via the first communication link, and the first time interval different from a second time interval associated with control signaling for SRSs transmitted by the second network entity via the second communication link.

28. The method of claim 27, further comprising:
receiving, in response to the control signaling, the one or more SRSs on the set of time resources at the first time interval from transmission of the control signaling.

29. The method of claim 27, further comprising:
receiving the one or more SRSs at the first time interval, wherein the first time interval is greater than or equal to a third time interval starting from transmission of the control signaling via the first communication link, the third time interval comprising a time interval in which transmission of the one or more SRSs is restricted.

30. The method of claim 27, further comprising:
transmitting one or more channel state information reference signals (CSI-RSs) at a fifth time interval from transmission of the control signaling, the fifth time interval identified according to the control signaling transmitted via the first communication link, and the fifth time interval different from a sixth time interval associated with CSI-RSs transmitted by the second network entity via the second communication link.
